(19) United States
(12) Patent Application Publication
(10) Pub. No.: US 2019/0263557 A1
(43) Pub. Date: Aug. 29, 2019

(54) IMITATION EGG PRODUCT

(71) Applicant: David A. KULMAN, Falls Church, VA (US)

(72) Inventor: David A. KULMAN, Falls Church, VA (US)

(21) Appl. No.: 16/284,039

(22) Filed: Feb. 25, 2019

Related U.S. Application Data
(60) Provisional application No. 62/634,329, filed on Feb. 23, 2018.

(51) Int. Cl. B65D 8/00; A23L 15/00; B65D 65/46; B65D 85/32; B65D 81/34

(52) U.S. Cl. CPC B65D 11/02; A23L 15/35; A23V 2002/00; B65D 85/32; B65D 81/34; B65D 65/466

(57) ABSTRACT

A whole-egg replacement or imitation egg product may be provided. The whole-egg replacement may have an extended shelf life and may be available in a variety of commercial markets. The imitation egg product may be formulated to be vegan and/or allergy friendly based on the specific ingredients chosen. The imitation egg product may also provide a sensory experience similar to that of a natural egg, by being of the approximate size and shape of a chicken egg and being able to be cracked open in a similar manner.

### CROSS-REFERENCE TO RELATED APPLICATIONS

This application claims priority from U.S. Provisional Patent Application No. 62/634,329, filed on Feb. 23, 2018, entitled “Imitation Egg Product,” the entire contents of which are hereby incorporated by reference.

### BACKGROUND

In the past twenty years there has been a dramatic increase in both people choosing to live a vegan lifestyle, and those who have been diagnosed with food allergies, specifically an allergy to natural egg proteins. Until recently, there have been very few options for these groups to find a feasible replacement for natural eggs. There are products that offer various configurations of natural eggs in alternative formats, such as powdered eggs and Egg Beaters®, but these are not acceptable by vegans or those allergic to egg proteins.

Currently the vegan and allergy sensitive communities are limited in their choices of viable egg-replacements. Consequently, many vegan and/or allergy friendly replacements for the common avian egg, in particular a chicken or duck egg, have been under development. However, no product has successfully mimicked all of the aspects in a manner that is commercially acceptable and feasible.

Some powdered products are meant to replicate certain features of natural eggs, but these are typically limited to baking and/or as a scrambled egg substitute. These products also require precise measuring and mixing in order to use. There are numerous powdered products, that can be used in baking to replace either egg-whites, egg-yolks or possibly even whole eggs. But these have to be mixed with water and are only useful as ingredient replacer in recipes. There is also a powdered product that attempts to replicate the characteristics of scrambled eggs, and a newly invented product that intends to replicate a solid state hard-boiled egg. However, all of these products lack the physical characteristics associated with an uncooked, shelled, whole egg, such as the ability to be cracked open or boiled and none of these current products are able to contain vegan egg replacers in the expected states—separate yolk and white—that is common to an avian egg.

It therefore may be desirable to create a convenient and complete whole-egg replacement that has an extended shelf life and can be made available in a variety of commercial markets.

### SUMMARY

A whole-egg replacement or imitation egg product may be provided. The whole egg replacement may have an extended shelf life and may be available in a variety of commercial markets. The imitation egg product may be formulated to be vegan and/or allergy friendly based on the specific ingredients chosen. The imitation egg product may also provide a sensory experience similar to that of a natural egg, by being of the approximate size and shape of a chicken egg and being able to be cracked open in a similar manner. This may allow the whole-egg replacement to replicate the entire life-cycle of storage, use, and consumption of a natural egg.

Furthermore, a vegan and allergy sensitive food package may be provided that can contain food product(s), such as a vegan or allergy sensitive egg yolk and egg white, in a manner that the packaging can be boiled, or if desired can be easily cracked open to reveal its contents in a manner that mimics a natural egg shell.

In an exemplary embodiment, a breakable, ovoid food container may be disclosed. The container may be made of two or more pieces to form the ovoid shape. The pieces may be sealed together at a seam. At least one of the pieces may contain an access aperture. The access aperture may be sealed with a cover.

In another embodiment may be an imitation egg. The imitation egg may include a breakable, ovoid packaging container. The container may contain a synthetic egg white material. The container may also contain a synthetic egg yolk.

Further, in another embodiment, a method for imitating a natural egg may be disclosed. The method may include assembling a food packing container. A synthetic yolk may be placed inside before the container is sealed. The container may have an access aperture. A synthetic egg white material may then be added through the access aperture. The access aperture may then be sealed.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

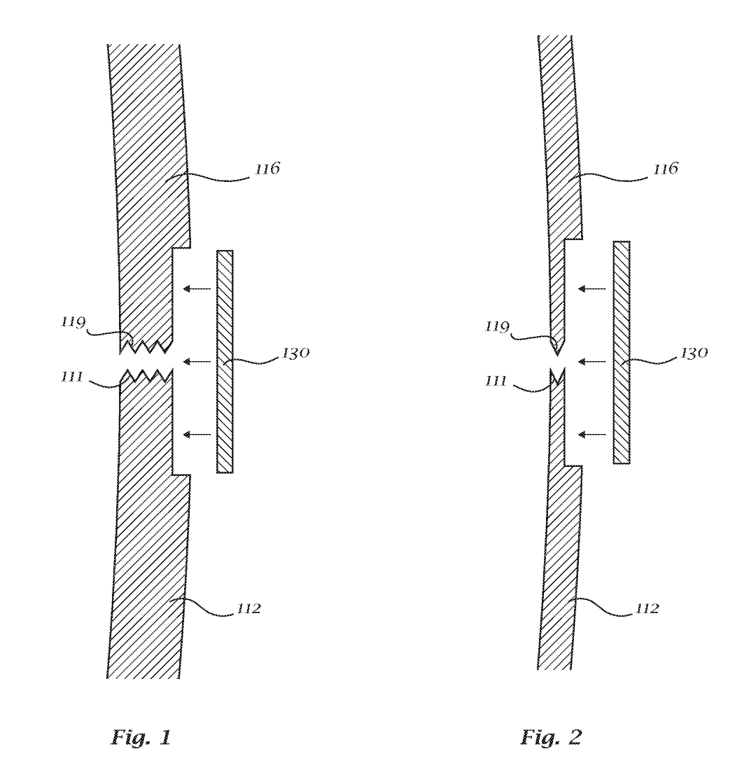

Exemplary FIG. 1 shows an imitation egg product seam.

Exemplary FIG. 2 shows an imitation egg product seam.

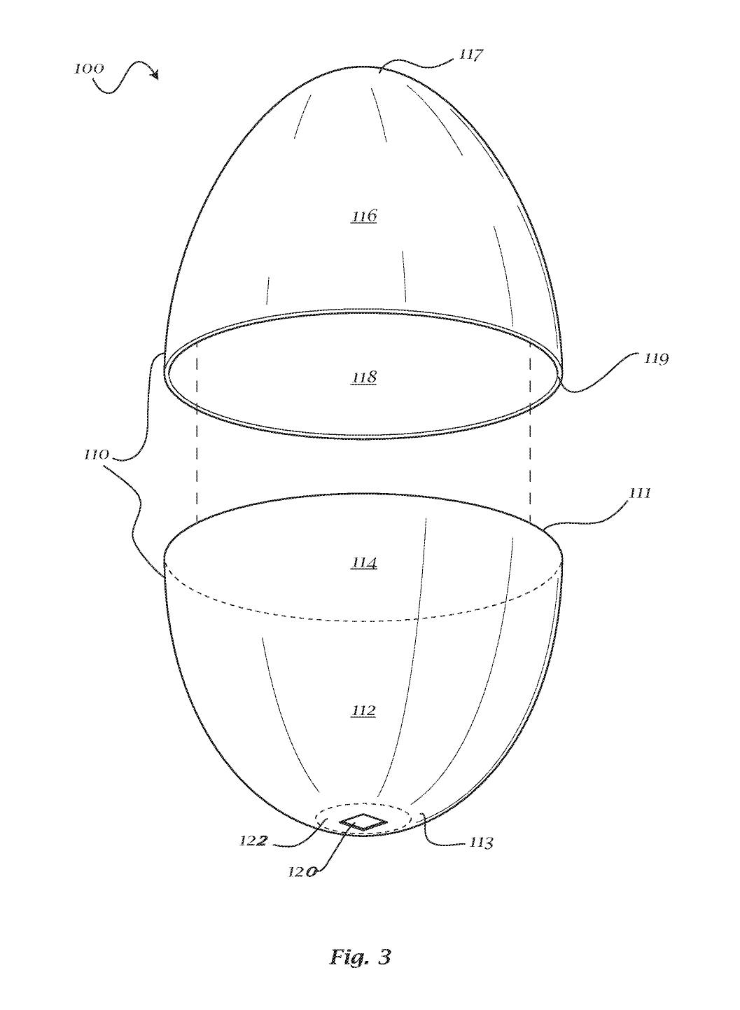

Exemplary FIG. 3 shows an assembled imitation egg product container.

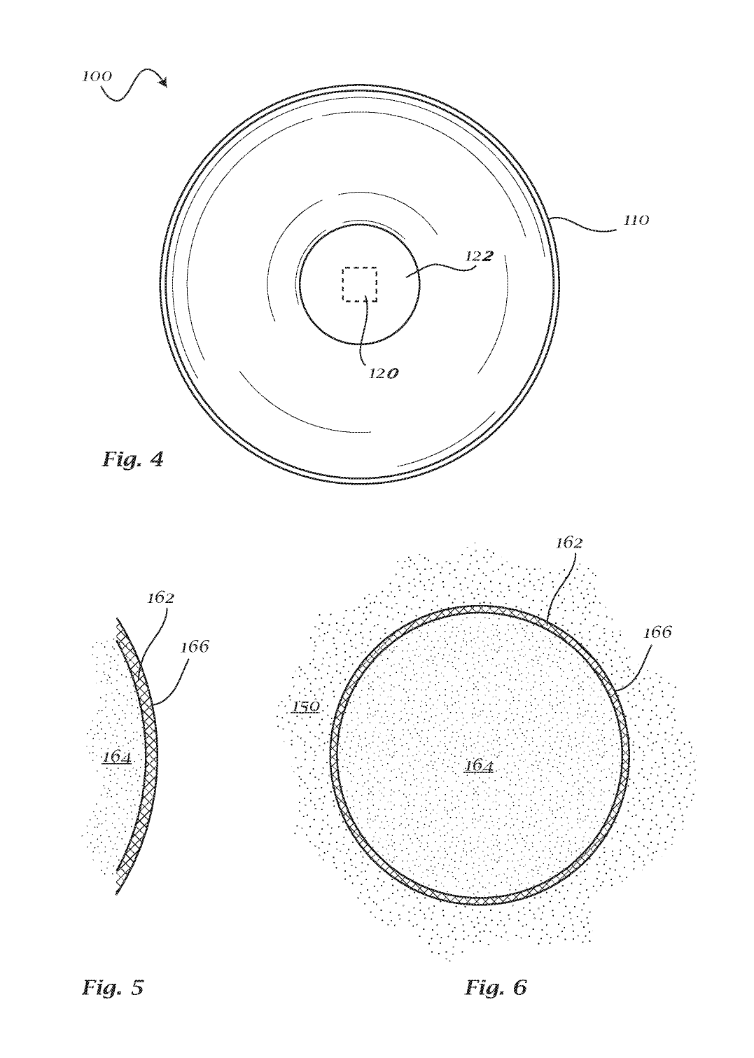

Exemplary FIG. 4 shows an imitation egg product container with an access aperture.

Exemplary FIG. 5 shows a cross section of imitation egg yolk with a membrane.

Exemplary FIG. 6 shows an assembled imitation egg product with imitation yolk and imitation egg white.

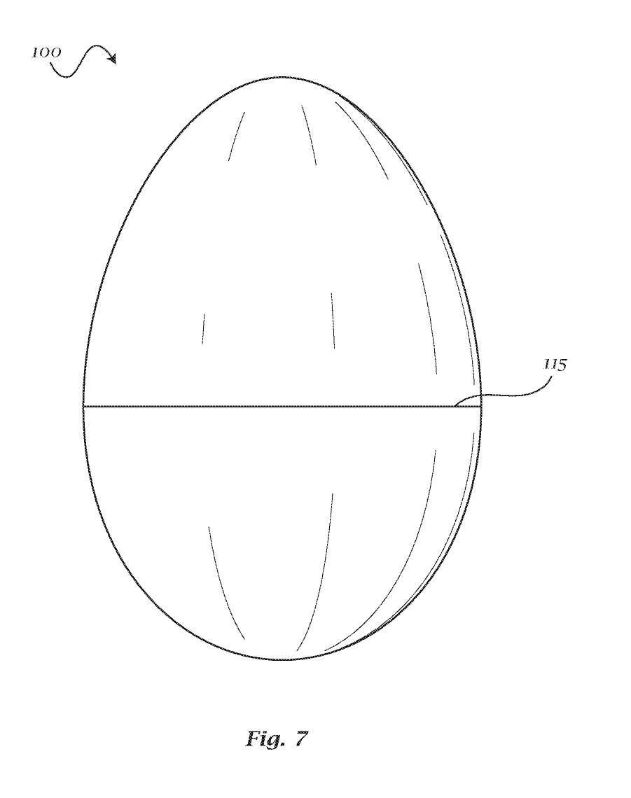

Exemplary FIG. 7 shows an imitation egg product from the side view

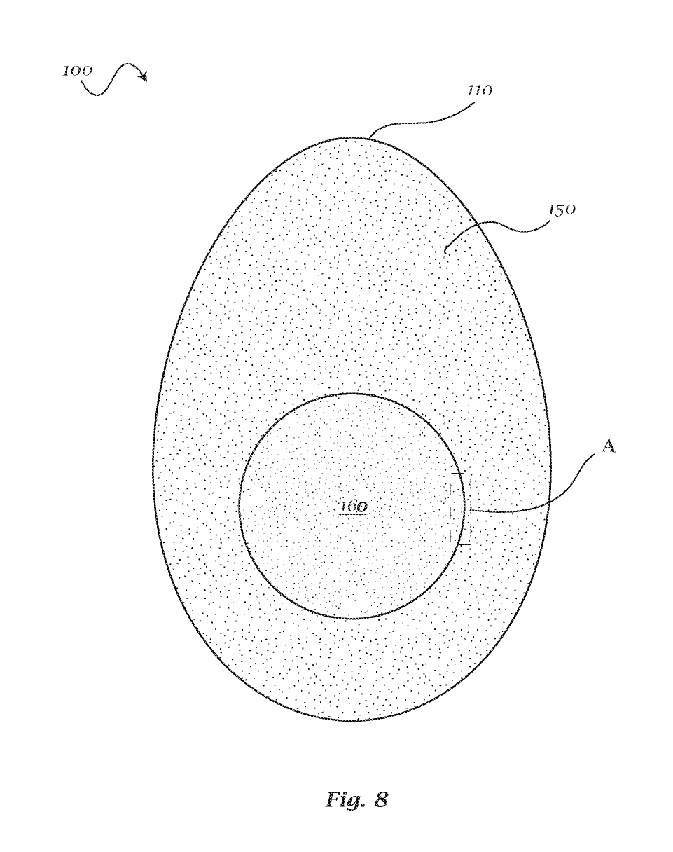

Exemplary FIG. 8 shows a cross section of an assembled imitation egg product with imitation yolk and imitation egg white.

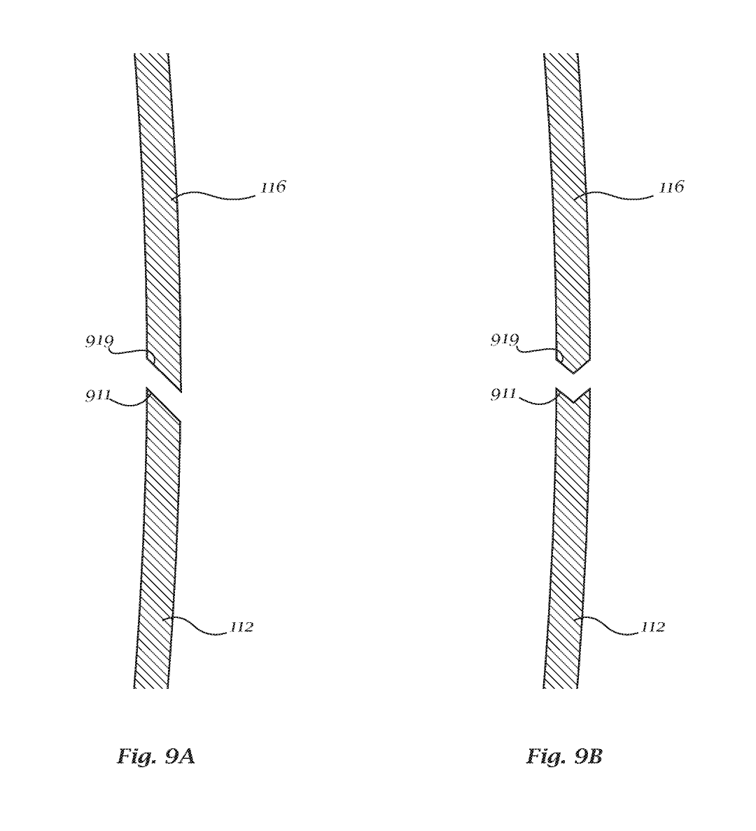

Exemplary FIG. 9A shows an imitation egg product seam.

Exemplary FIG. 9B shows another imitation egg product seam.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, as shown in the Figures generally, an imitation egg 100 may be provided. The imitation egg 100 may include a shell 110, which may form a substantially hollow ovoid shaped structure when assembled. The imitation egg 100 may imitate a chicken egg in size, in shape, in color, in texture, or in fragility. In an exemplary embodiment, the imitation egg 100 may imitate a chicken egg in size, in color, in texture, and in fragility. In another exemplary embodiment, the imitation egg 100 may imitate eggs of other fowl, including quails, ostriches, and ducks, in size, in shape, in color, in texture, or in fragility. Shell 110 may be a solid outer structure, which may also act as a packaging mechanism for interior contents, when assembled. The shell 110 may have an average wall thickness similar to that of a natural chicken egg. Maintaining a thickness less than double that of a natural egg shell may allow the imitation egg to feel like a natural chicken egg. Maintaining a thickness strong enough to mirror the integrity of a natural egg may allow the imitation egg 100 to be handled and stored, and to feel like a natural chicken egg. In one embodiment, the shell 110 may have an average wall thickness from about 0.2 millimeters to about 0.59 millimeters. In another embodiment the shell 110 may have an average wall thickness from about 0.4 millimeters to about 0.8 millimeters. Other thicknesses may be permittable provided that they do not interfere with the integrity or functionality as described. The shell 110 may have thicker or thinner walls near openings to allow for seals and other functions. The shell 110 may be thin enough to allow for intentional breaking by the consumer. The shell 110 may be thick enough to minimize accidental breaking during production, shipping, or storage. Imitation egg 100 may further include a yolk 164, which may be a solid, liquid, or semi-solid combination of edible ingredients that are formed and self-contained as a separate monolithic entity. The yolk 164 may embody properties similar to those of a chicken egg yolk. Furthermore, imitation egg 100 may include egg white material 150, which may be solid, liquid, or semi-solid edible ingredients disposed inside of shell 110. The egg white material 150 may surround/envelope the yolk 164.

According to an exemplary embodiment, shell 110 may be made of at least two pieces. The shell 110 may be produced by injection molding or vacuum forming. Shell 110 may have a base cup 112 and a top cup 116. The base cup 112 and top cup 116 may each comprise at least about 25% of the total surface area of the whole shell 110. Shell 110 may be split along a transverse axis, forming base cup 112 below the split and top cup 116 above the split. The diameters of each cup 112, 116 at its widest point may be equal to or greater than about 50% of the diameter of the shell 112 at its widest point along the same axis. Each cup 112, 116 may have an adjoining opening. The adjoining opening may have a diameter that is greater than half the diameter of the assembled container's widest point along the same axis. This may ensure that the yolk may fit through the adjoining opening, and may also allow the adjoining seam to occur somewhere other than just at the widest point of the seams axis. In some alternative exemplary embodiments, shell 110 may alternatively be divided into at least two pieces along a longitudinal axis or any other desired divisions, as would be understood by a person having ordinary skill in the art. Base cup 112 may be a cup, with a closed end 113 and open end 114. In some embodiments, base cup 112 may be substantially shaped like the bottom half of an egg. Base cup 112 may optionally have a flat portion for standing upright on closed end 113. In other embodiments, base cup 112 may optionally have a rounded bottom. Similarly, top cup 116 may be a cup. The top cup 116 may have a closed end 117 and an open end 118, and optionally may be shaped like the top half of an egg. Other exemplary embodiments may have top and bottom cups shaped like other variations of ovoid shapes.

The open ends 114, 118 of base cup 112 and top cup 116, respectively, may be joined to form a complete shell 110. Base cup 112 may have a base cup joint edge 111 and top cup 116 may have a top cup joint edge 119. Open ends 114, 118 may have substantially matching cross-sectional shapes, such that joint edges 111 and 119 match up, as would be understood by a person having ordinary skill in the art. Joint edges 111 and 119 may be sealed together forming joint 115. Joint 115 may be sealed using adhesives, adhesive tapes, heat sealing, welding, or other sealing methods understood by a person having ordinary skill in the art. Joint 115 may be sealed in such a manner that it may be water resistant, waterproof, and/or heat resistant. The seal of joint 115 may optionally be permanent. Furthermore, joint edges 111 and 119 may be substantially smooth, or may be uneven. For example, joint edges 111 and 119 may be jagged or otherwise have matching undulations, as shown in exemplary FIGS. 1 and 2. In some alternative embodiments, joint 115 may be temporary, allowing shell 110 to be cracked along joint 115. In yet further exemplary embodiments, joint 115 may have a similar fracture or tensile strength to shell 110, allowing shell 110 to optionally be fractured along, across, or away from joint 115. The assembly and joining of all shell components may be accomplished through adhesives, epoxy resins, waxes, adhesive tapes, heat sealing, welding, or other sealing methods understood by a person having ordinary skill in the art. Exemplary welding techniques may include friction welding, high frequency welding, laser welding, solvent welding, spin welding or ultrasonic welding. All seals and joints discussed herein may optionally be food safe, waterproof, and/or temporary or permanent. As shown in exemplary FIGS. 1 and 2, joint edges 111, 119 may be indented or offset from the rest of shell 110, such that a track is formed for applying an adhesive tape 130 or other sealing material along joint 115. In alternative exemplary embodiments, as show in exemplary FIGS. 9a and 9b, the joint 115 may be sealed without offset joint edges. Joint edges 911 and 919 may be flush with the shape of the shell instead of being indented. Joint edges 911 and 919 may then be sealed with an adhesive or other means of bonding, as described elsewhere herein or as would be known by a person having ordinary skill in the art.

The base cup 112 or top cup 116 may further include at least one aperture 120. According to at least one exemplary embodiment, aperture 120 may be disposed in top cup 116 proximate the apex of closed end 117. Aperture 120 may be sized and shaped in a manner as to prevent the “yolk” 164 from passing through the aperture. Aperture 120 may have a diameter of no more than half the diameter of the shell 110 at its widest point along the short axis. In other exemplary embodiments aperture 120 may be formed in both base cup 112 and top cup 116. Aperture 120 may allow access to the interior of shell 110 after joint 115 is sealed.

According to an exemplary embodiment, the separateness of base cup 112 and top cup 116 may allow for the insertion of a solid or semi-solid state material, such as a monolithic “egg-yolk,” which may have adequate and realistic proportions comparable to a natural egg. Joint 115 may be sealed after one or more desired material, such as an “egg-yolk” material, is inserted within shell 110. In some exemplary embodiments, some “egg-white” material may be inserted with “egg-yolk” material. Once joint 115 is sealed, additional contents may be deposited through aperture 120. For example, liquid contents may be deposited to further fill shell 110. The additional contents deposited through aperture 120 may optionally include natural or synthetic “egg-white” material.

Aperture 120 may be sealed with a cover seal 122, which may optionally be a membrane, plug, or other insert, as would be understood by a person having ordinary skill in the art. Seal 122 may be rigid, flexible, and/or expandable. Seal 122 may optionally be removable to allow for future access to the interior of shell 110 without cracking shell 110. This may permit the withdraw of certain contents or depositing of additional contents within shell 110. In yet other embodiments, seal 122 may be permanently applied or adhered, such that the interior of shell 110 cannot be readily accessed through aperture 120 once sealed, as would be understood by a person having ordinary skill in the art. Seal 122 may be an adhesive membrane, which may be sealed to shell 110 using its adhesive properties. Seal 122 may optionally have material properties similar to shell 110. In some embodiments, seal 122 may be the same material as shell 110. In some embodiments the seal cover may be rigid, while in others it may be flexible. Furthermore, seal 122 may optionally have a shape in accordance with the substantially ovoid shape of shell 110. Seal 122 may be impermeable under refrigerated or room temperature storage conditions, but may become permeable or semi-permeable at cooking temperatures, thus allowing the release or exchange of gasses during cooking.

Shell 110 may optionally be translucent or opaque. The material or materials of shell 110 and seal 122 may optionally be food safe and may be capable of acting as a water, gas and oil barrier. The shell 110 and/or seal 122 may made of a material or materials that could be dyed during production. The dye color may imitate the color of a natural chicken egg. In some embodiments, shell 110 and/or seal 122 may be thermoformable. Furthermore, shell 110 and/or seal 122 may be fragile, such that it is non-flexible, rigid, and has tensile properties comparable to a natural egg shell. The fragile nature of shell 110 and/or seal 122 may allow it to be cracked similar to a natural egg to access the interior. As referenced above, there may optionally be design modifications, such as channels, seams, grooves, or other stress points, which may promote, target or direct cracking points. Shell 110 and/or seal 122 may be made of a material or materials having high heat resistance, which may include a Long Term Service Temperature above approximately 100 degrees Celsius, preferably above 102 degrees Celsius. The material or materials may withstand storage temperatures from about 0 degrees Celsius to about 50 degrees Celsius. The material or materials may also be impermeable at storage temperatures from about 0 degrees Celsius to about 50 degrees Celsius. According to some exemplary embodiments, the material or materials may be capable of withstanding extended cooking temperatures of at least about 220 degrees Celsius. According to further exemplary embodiments, the material or materials of at least one of the shell 110 or seal 122 may also become permeable at extended cooking temperatures of at least about 90 degrees Celsius. The material or materials of the shell 110 and/or seal 122 may become permeable when it goes from storage to cooking temperatures to allow for gas exchange at cooking temperatures. This may permit boiling, baking, or otherwise cooking contents within shell 110, as would be understood by a person having ordinary skill in the art. According to at least one exemplary embodiment, shell 110 and/or seal 122 may be made of Styrene-maleic anhydride (SMA). According to other exemplary embodiments, shell 110 and/or seal 122 may optionally be made of any material exhibiting the desired properties, as would be understood by a person having ordinary skill in the art.

The material of shell 110, including any sealing materials, may be biodegradable. The preferred biodegradable nature of the material may be “oxo-degradable,” which may be degradable in a variety of environmental conditions, not merely through recycling or industrial composting environments available only in limited markets. The biodegradable nature of shell 110 may be influenced by the use of additives, such as “oxo-biodegradable” additives. Furthermore, the material of shell 110 may include recycled resins. Yet other embodiments, may further include additives to improve or achieve desired rheological, physical or tensile properties. These additives may optionally including Zinc, Talc, Calcium Carbonate or other mineral additives.

Now referring to exemplary FIGS. 5 and 6, an imitation egg may further have edible components, which may be stored within an outer shell 110. Interior edible components may include at least one of a liquid “egg-white” material 150 and/or an “egg-yolk” 160. The “egg-white” material 150 and “egg-yolk” 160 may contain either natural egg components, and/or, any combination of other natural, artificial, synthetic or otherwise processed ingredients acting as replacements for such components. In some embodiments, “egg-yolk” 160 may be comprised of a synthetic vitelline membrane 162 used to surround and encapsulate yolk material 164. An example technique and composition of such a membrane may be found in U.S. Pat. No. 5,192,566, issued to Cox. However, existing techniques and compositions may present issues derived from osmosis and/or migration of fluids over time. To address these issues, an additional layer, or multiplicity of layers, that is both liquid and gas impermeable may be incorporated. According to some exemplary embodiments, the liquid and gas impermeable layer(s), or hydrophobic layer(s) 166 may be formed by coating the vitelline membrane with lipids, waxes, proteins, or similar hydrophobic compounds. Layer(s) 166 may have a melting point from approximately 40 degrees Fahrenheit to approximately 60 degrees Fahrenheit. Layer(s) 166 may be formed on the interior, exterior, or both interior and exterior of the vitelline membrane 162. FIGS. 5 and 6 show portion A of FIG. 8.

An exemplary imitation egg 100 may be assembled by supplying a shell 110, which may include unassembled components of a base cup 112 and top cup 116. inserting a yolk-component 160 in a base cup 112. A top cup 116 may then be sealed to base cup 112, encapsulating the yolk-component 160. Top cup 116 may further include an aperture 120. Aperture 120 may be sized such that the yolk-component 160 may not be capable of passing through aperture 120. An egg-white material 150, which may optionally be liquid, may then be deposited into shell 110. Shell 110 may be filled to a desired volume, which in some embodiments may be substantially full. Once shell 110 has been filled to the desired volume, a seal 122 may be used to seal aperture 120, forming a complete imitation egg product 100.

In some embodiments, shell 110 may be used independently from the imitation egg contents. Shell 110 may alternatively be used to contain any desired contents, as would be understood by a person having ordinary skill in the art.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A breakable, ovoid food packaging container, wherein the food packaging container comprises at least two cup-shaped container pieces that assemble to form an ovoid shape,
wherein the at least two cup-shaped container pieces are sealed together at least one seam,
and wherein an access aperture is disposed in at least one of the at least two container pieces, the access aperture being located separate from the seam and being sealed with a sealing cover.

2. The food packaging container in claim 1, wherein the container pieces each represent at least 25% of the combined surface area of the container.

3. The food packaging container in claim 1, wherein the at least two container pieces have openings with a diameter of at least 50% of the diameter of the food packaging container at the widest point along the same axis.

4. The food packaging container in claim 1, wherein the at least one seam between container pieces is continuous, and permanent.

5. The food packaging container in claim 1, wherein the access aperture is configured to prevent migration of a yolk and allow insertion and extraction of a liquid material.

6. The food packaging container in claim 1 wherein the sealing cover permanently seals the access aperture.

7. The food packaging container in claim 1 wherein the aperture sealing cover is removable to access contents.

8. The food packaging container in claim 1, wherein the food packaging container is impermeable at storage temperatures.

9. The food packaging container in claim 1, wherein the food packaging container is capable of withstanding cooking temperatures.

10. The food packaging container in claim 1, wherein either or both the sealing cover and/or at least two cup-shaped container pieces are permeable to gases at cooking temperatures.

11. The food packaging container in claim 1, wherein the at least two container pieces are made of a thermoformable poly-based or compounded resin.

12. The food packing container in claim 1, wherein the container pieces are made using injection molding or vacuum forming.

13. The food packaging container in claim 1, wherein the container is biodegradable.

14. The food packaging container in claim 1, further comprising at least one of additives, fillers, and colorants.

15. An imitation egg comprising; a breakable food packaging container, wherein the food packaging container comprises at least two cup-shaped container pieces that assemble to form an ovoid shape,
wherein the at least two cup-shaped container pieces are sealed together at least one seam, wherein an access aperture is disposed in at least one of the at least two container pieces, the access aperture being located separate from the seam and being sealed with a sealing cover; a synthetic egg white material disposed within the breakable food packaging container; and a synthetic egg yolk disposed within the food packaging container.

16. The imitation egg in claim 15 wherein the synthetic egg yolk is larger than the access aperture.

17. The imitation egg in claim 15, wherein the synthetic egg yolk has a vitelline membrane comprised of an initial layer and a secondary layer.
